(19) United States
(12) Patent Application Publication
(10) Pub. No.: US 2021/0343134 A1
(43) Pub. Date: Nov. 4, 2021

(54) LAWN MOWER BARRIER

(71) Applicant: AUTRONI AS, NORDRE FROGN (NO)

(72) Inventors: Olav DVERGSDAL, NORDRE FROGN (NO); Roar BJERKE, NORDRE FROGN (NO); Øyvind BØHLERENGEN, NESODDTANGEN (NO)

(21) Appl. No.: 17/280,095

(22) PCT Filed: Sep. 27, 2019
(86) PCT No.: PCT/NO2019/050196

§ 371 Date: Mar. 25, 2021

(30) Foreign Application Priority Data
Oct. 3, 2018 (NO) 20181280

(51) Int. Cl. G08B 21/18; F16L 11/12

(52) U.S. Cl. CPC G08B 21/18; A01D 34/008; F16L 11/12

(57) ABSTRACT

A lawn mower barrier (3; 3′) for restricting autonomous lawn mowers (2) to a designated area (4). The lawn mower barrier comprises an elongate, pliable barrier body (5; 5′) with two terminal ends (6a,b; 6a′,b′), the barrier body (5; 5′) is a fluid proof container comprising a hollow space (7); the terminal ends (6a,b; 6a′,b′) are configured for connection to each other to form a closed loop, and the lawn mower barrier (3; 3′) comprises a valve (12a; 12b) for filling the barrier body (5) with a fluid.

### CROSS-REFERENCE TO RELATED APPLICATIONS

This application is the U.S. National Phase under 35. U.S.C. § 371 of International Application PCT/NO2019/050196, filed Sep. 27, 2019, which claims priority to Norwegian Patent Application No. 20181280, filed Oct. 3, 2018. The disclosures of the above-described applications are hereby incorporated by reference in their entirety

### FIELD OF THE INVENTION

The invention relates to a lawn mower barrier, and more specifically to a lawn mower barrier for autonomous lawn mowers.

### BACKGROUND

In order to restrict movement of autonomous lawn mowers to a designated area, most autonomous lawn mowers comprise a control system. Such a control system could be a GPS, and the autonomous lawn mowers are controlled to move within a designated area defined by GPS coordinates. Another means for restricting movement of autonomous lawn mowers is to place a wire along the periphery of the designated area, and the control system is designed such that the autonomous lawn mowers will not cross the wire in the ground below it.

However, mishaps and errors can occur, and at high-risk areas such as close to runways at airports an aforementioned control system is not enough; a physical barrier is required to prevent the lawn mowers from accidentally moving e.g. onto a runway in case the control systems fail. Lawn mowers generally have low clearance to the ground, but are designed to pass by humps and unevenness on the ground.

A physical barrier must be resilient enough to not collapse or move in case a lawn mower bumps into it. Different physical barriers exist, such as fences, bricks etc, but it is difficult and time-consuming to set them up and remove them, or even adjust them.

A physical barrier for autonomous lawn mowers may not be needed e.g. during winter, and it should therefore be easy to both install, remove and store. In the event of an accident, mishap or other extraordinary event near or on the area defined by the barrier, it is also advantageous if it is possible to pass by the barrier in both personal vehicles as well as planes moving on the ground, without putting at risk the passengers of the personal vehicle or airplane, and without compromising the integrity of the physical barrier.

Documents useful for understanding the field of technology includes the following: U.S. Pat. No. 5,720,678 A describes a hollow inflatable barrier for sports games. A fan or blower is connected to the barrier and provides a continuous stream of air into the barrier to keep it inflated. U.S. Pat. No. 5,157,867A describes an elongate landscape edging strip. U.S. Pat. No. 5,323,593 describes an unattended lawn mowing system with multiple lawn mowers. U.S. Pat. No. 3,540,699A describes a device for preventing or hindering motor vehicles from going off a roadway. WO2009019681A1 describes a modular barrier unit where a number of which can be used for erecting a modular unit. US 2018/213719 A1 describes a doorway system for a robotic vehicle that accesses a separated area through a barrier.

It is therefore a need for an improved physical barrier for autonomous lawn mowers to reduce or eliminate the abovementioned disadvantages of known techniques. It is an objective of the present invention to achieve this and to provide further advantages over the state of the art.

### SUMMARY

In an embodiment, there is provided a lawn mower barrier for restricting autonomous lawn mowers to a designated area. The lawn mower barrier comprises an elongate, pliable barrier body with two terminal ends. The barrier body has a diameter between 5-30 cm and is a liquid proof container comprising a hollow space. The terminal ends are configured for connection to each other to form a closed loop, the lawn mower barrier comprises a valve for filling the hollow space with a liquid.

According to another embodiment, the valve is provided at one of the terminal ends.

According to another embodiment, a valve is provided at both terminal ends.

According to another embodiment, the lawn mower barrier comprises at least one pressure sensor for detecting leakage from the lawn mower barrier.

According to another embodiment, the at least one pressure sensor is provided at a terminal end.

According to another embodiment, the pressure sensor is in communication with a controller, and the controller is configured to trigger an alarm in case of a leakage from the barrier body.

According to another embodiment, the liquid is water.

According to another embodiment, the barrier body comprises a rotationally symmetrical cross-section.

According to another embodiment, the lawn mower barrier further comprises a perimeter wire.

According to another embodiment, a plurality of lawn mower barriers can form a lawn mower barrier assembly.

There is also provided a method of restricting autonomous lawn mowers to a designated area, comprising the steps of placing at least one lawn mower barrier along at least a portion of the periphery of the designated area and filling the at least one lawn mower barrier with a liquid.

According to another embodiment the method further comprises the step of connecting the at least one lawn mower barrier end-to-end.

### BRIEF DESCRIPTION OF THE DRAWINGS

The above and other characteristics will become clear from the following description of embodiments, given as non-restrictive examples, with reference to the attached schematic figures.

FIG. 1 is a top view of a lawn mower barrier restricting movement of autonomous lawn mowers to a designated area.

FIG. 2 is a side view of a lawn mower and a cross section of a lawn mower barrier filled with a fluid.

FIG. 3 illustrates a first embodiment of terminal ends of a lawn mower barrier connected to each other, and a pressure sensor.

FIG. 4 illustrates a second embodiment of terminal ends of a lawn mower barrier with valves and pressure sensors.

FIG. 5 illustrates a portion of an embodiment of a lawn mower barrier comprising a perimeter wire and a power outlet.

### DETAILED DESCRIPTION

The following description may use terms such as “horizontal”, “vertical”, “lateral”, “upper”, “lower”, “inner”, “outer”, “forward”, “rear”, etc. These terms generally refer to the views and orientations as shown in the figures and that are associated with a normal use of the invention. The terms are used for the reader's convenience only and shall not be limiting.

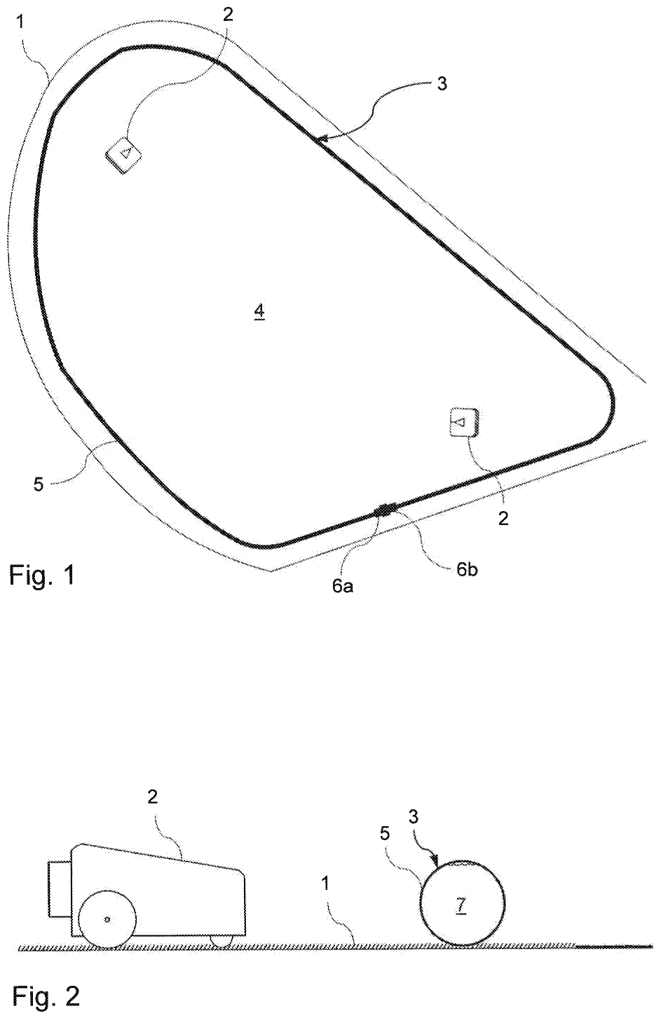

Referring initially to FIGS. 1 and 2, a lawn 1 is illustrated with autonomous lawn mowers 2. A lawn mower barrier 3 is positioned along the periphery of the lawn 1 to restrict movement of the autonomous lawn mowers 2 and provide a physical safety barrier in case the control systems of the autonomous lawn mowers 2 fail. A designated area 4 for the autonomous lawn mowers 2 is thus defined by the lawn mower barrier 3. The lawn mower barrier 3 prevents autonomous lawn mowers 2 from leaving the designated area 4 and moving to another, unwanted area outside the lawn mower barrier 3. The unwanted area may be a runway at an airport, a motorway, or other area in which small, autonomous vehicles may pose a great danger if they enter.

The lawn mower barrier 3 comprises an elongate barrier body 5 with two terminal ends 6a,b. It is in this context understood that the barrier body 5 thus has a length that is far greater than the width. The terminal ends 6a,b are configured to be connected to each other, such that the lawn mower barrier 3 forms a closed loop, as illustrated in FIG. 1. However, the terminal ends 6a,b need not be connected to each other, if the lawn mower barrier 3 is to cover only part of the periphery of a designated area 4. If the lawn mower barrier 3 forms a closed loop, the autonomous lawn mowers 2 are prevented from leaving the designated area 4 defined by the lawn mower barrier 3. The barrier body 5 may be from a few meters long up to hundred meters and more.

The barrier body 5 is pliable, and may be static or flexible. The barrier body 5 comprises a hollow space 7 which extends along the length of the barrier body 5. The barrier body 5 may be formed similarly to a hose. As the barrier body 5 is pliable, it may easily be collapsed when not in use. The lawn mower barrier 3 can as such be rolled up and stored in a rolled-up position. This allows for both easy installation and removal, transportation and storage of the lawn mower barrier 3.

The terminal ends 6a,b may be angled, or may be connected to an angled element, such that a defined angle may be introduced to the lawn mower barrier 3. E.g. if a 90° bend is desirable, in order to conform the lawn mower barrier 3 to a specific shape of the designated area 4, the 90° bend could be established at the connection between two terminal ends of a lawn mower barrier.

In order to increase the volume and the mass of the barrier body 5, and make it firm and capable of withstanding an impact with an automated lawn mower 2, the hollow space 7 of the barrier body 5 is filled with a fluid, as illustrated in FIG. 2. The barrier body 5 is thus a fluid proof container. The fluid may be a liquid such as water, or other low-cost and easy accessible fluid. The hollow space 7 may be filled with a fluid at a terminal end 6a or 6b, through a valve. A valve for filling the hollow space 7 may as such be positioned anywhere on the lawn mower barrier 3. The lawn mower barrier 3 may be filled with a fluid prior to connecting the terminal ends 6a,b to themselves. When filled, the pressure from the fluid exerted on the barrier body 5 makes it expand into a shape determined by the construction of the barrier body 5, and the lawn mower barrier 3 is thus established with a given width and height of the barrier body 5. A lawn mower barrier 3 filled with a fluid also adds weight to the barrier, such that the lawn mower barrier 3 will adapt to the bumps and contours of the ground and thus provide a very adaptable lawn mower barrier 3. A lawn mower barrier 3 filled with a fluid will also make the lawn mower barrier rigid and resilient.

The fluid may be coloured, such that leakage is easy to detect. The fluid inside the lawn mower barrier 3 may also be fluorescent in order to enhance probability of detecting a leakage before the integrity of the barrier is compromised. The lawn mower barrier 3 may in an alternative embodiment be filled with a foam or similar substance.

The terminal ends 6a,b of a lawn mower barrier 3 may be connected to terminal ends of other lawn mower barriers 3, such that a plurality of lawn mower barriers 3 may be serial-connected to each other to form a barrier assembly of any length. A lawn mower barrier assembly thus comprises a plurality of lawn mower barriers 3, connected end-to-end, in order to define designated areas of various perimeter length. The lawn mower barriers 3 may have barrier bodies 5 of individual length and cross-section, meaning they could be different in length and cross-section, but may also be identical. The lawn mower barriers 3 of a lawn mower barrier assembly may be filled with a fluid prior to being connected to each other.

The barrier bodies 5 can also be provided in different lengths, and with different cross-sections. A lawn mower barrier 3 may comprise a barrier body 5 of a given length and cross-section, and at the terminal ends 6a,b it could be connected to other lawn mower barriers with different lengths and different cross-sections. Such variations allows a barrier consisting of a plurality of lawn mower barriers 3 to be adapted to the ground it is placed on.

Because the barrier body 5 is pliable and filled with a fluid, a segment of the lawn mower barrier 3 may be compressed and deformed if subjected to a sufficiently heavy load, for thereby to return to its original shape as the fluid pressure expands the barrier body 5 as the heavy load is removed. As such, the lawn mower barrier 3 allows large vehicles to compress and pass by the barrier, while autonomous lawn mowers 2 are not sufficiently heavy or have enough clearance to the ground to compress and pass by the lawn mower barrier 3. Such large vehicles may be personal transportation such as cars and trucks, and airplanes moving on the ground, etc. As the wheel of e.g. a car passes the lawn mower barrier 3, the weight of the car temporarily compresses the lawn mower barrier 3 flat towards the ground, but as the wheel of the car passes, the lawn mower barrier 3 retains its original shape.

The cross-section of the lawn mower barrier body 5 could be basically circular, as illustrated in FIG. 2. A circular, angular or otherwise rotationally symmetrical cross-section prevents unwanted effects related to the lawn mower barrier 3 being positioned up-side down or in other non-optimal positions. A rotationally symmetrical cross-section simplifies installation and removal of the lawn mower barrier 3 as it can be rolled out and rolled in, without consideration as to which orientation it has when it is rolled out onto the ground. The weight of the lawn mower barrier 3 and the fluid inside it keep the lawn mower barrier 3 securely positioned on the ground. As the lawn mower barrier 3 is placed on top of the ground, and does not need to be secured to the ground, it can be placed just as easily on lawn as on tarmac, rocks, etc. where a traditional fence or other barrier could be both difficult and undesirable to set up and secure.

A barrier body 5 with a circular cross section could have a diameter of between 5-50 cm. The diameter of the barrier body 5 may be between 10-40 cm, and more preferably between 5-30 cm. A cross section of the indicated dimensions is sufficient to prevent autonomous lawn mowers to pass by the lawn mower barrier 3, while both airplanes moving on the ground and personal vehicles can pass by the barrier without compromising the safety of the vehicle or the barrier.

A barrier body 5 may be made from materials such as rubber, PVC, Polyurethane, Neoprene and silicon, or it could be made from a fabric material, or a combination. The barrier body could also be reinforced with fabrics or fibres such as glass fibre and Kevlar. Reinforcements could add strength and durability to the body 5, in order to reduce the effects of wear and tear and increase the lifetime of the lawn mower barrier 3.

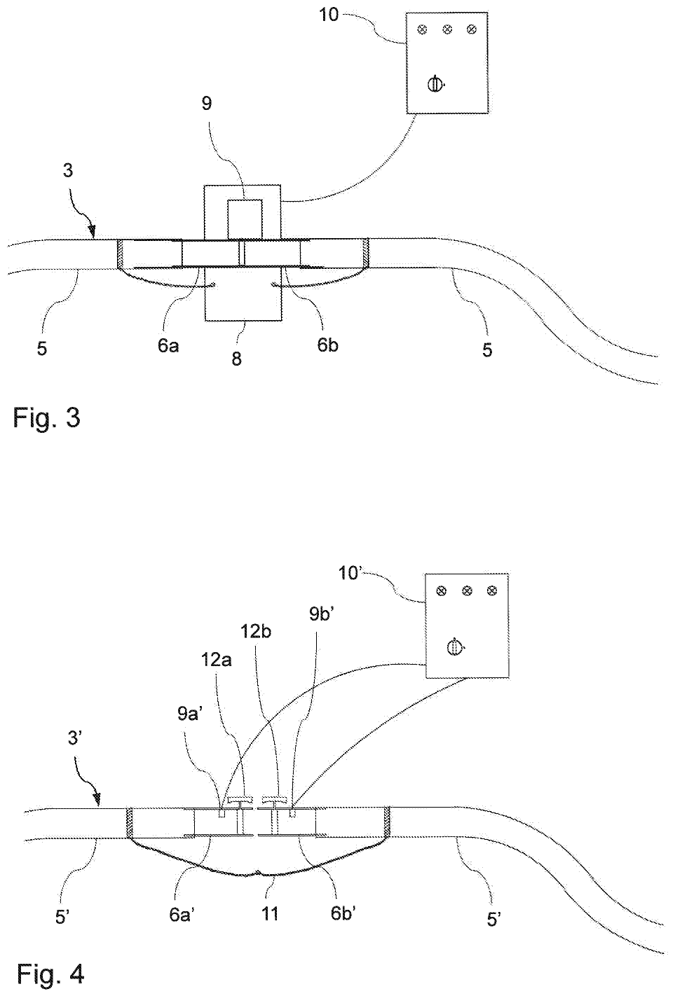

Referring now to FIG. 3, a first embodiment of terminal ends 6a,b of a lawn mower barrier 3 connected together is illustrated. Although not illustrated, one or both of the terminal ends 6a,b may comprise a valve through which fluid could be fed to the barrier body 5. The connection comprises a connector 8 between the two terminal ends 6a,b. As explained previously, the terminal ends 6a,b may be terminal ends of the same lawn mower barrier body, or it may be terminal ends from two separate barrier bodies 5, if a lawn mower barrier assembly comprises more than one lawn mower barrier 3. The connector 8 is in the illustrated embodiment a pressure-tight seal between the terminal ends 6a,b, and the terminal ends 6a,b are secured to each other and the connector 8 with a pin and chain. The terminal ends 6a,b may alternatively be secured directly to one another without a separate connector 8 by means of threaded connections, non-threaded gender couplers or genderless couplers, flanged couplings, and similar.

The lawn mower barrier 3 may comprise a pressure sensor 9. In the illustrated embodiment, the pressure sensor 9 is part of the connector 8, but the pressure sensor 9 may also be an integrated part of the terminal ends 6a or 6b of the lawn mower barrier 3, or even a part of the barrier body 5. A lawn mower barrier assembly comprising a plurality of lawn mower barriers 3 may thus comprise several pressure sensors 9. The pressure sensor 9 is configured to monitor the pressure inside the lawn mower barrier 3, and transmit status or deviations from a predetermined level to a controller 10. The pressure sensor 9 may be in communication with and transmit to the controller 10 over the air or via cable, depending on location and equipment.

If the lawn mower barrier 3 is compromised, i.e. a leakage occurs and the lawn mower barrier 3 is possibly not able to prevent autonomous lawn mowers to pass by it, the pressure sensor 9 will detect a pressure drop that is transmitted to the controller 10. The controller 10 may respond by triggering an alarm and automatically shut down the autonomous lawn mowers, to prevent them from accidentally leaving the designated area defined by the damaged lawn mower barrier 3. A notification of the compromised barrier could also be transmitted to e.g. mobile phones. The pressure inside a lawn mower barrier 3 could be e.g. between 0.5-1.5 bar, and a threshold for the controller 10 could be set equally. The pressure sensor 9 or controller 10 may be adjusted such that the pressure sensor system does not shut down the autonomous lawn mowers in case of a brief pressure increase, e.g. due to a heavy vehicle passing by and temporarily deforming the lawn mower barrier 3. The pressure sensor(s) 9 and controller(s) 10 could be configured such that upon a short but sudden pressure increase, the system could notify that a vehicle has likely passed the lawn mower barrier 3, and as such entered or left the designated area.

Referring now to FIG. 4, a second embodiment of terminal ends 6a′,b′ of a lawn mower barrier 3′ is illustrated. The terminal end 6a′ comprises a valve 12a, and another terminal end 6b′ comprises another valve 12b. As such, the lawn mower barrier 3′ may be filled from each terminal end, which may be far apart. Also, when placing the lawn mower barrier 3′, there is no need to take into account the orientation, i.e. which terminal end is positioned where, as the lawn mower barrier 3′ can be filled with a fluid at both terminal ends 6a′,b′. The terminal ends 6a′,b′ may be terminal ends of the same lawn mower barrier body, or it may be terminal ends from two separate barrier bodies, if a lawn mower barrier assembly comprises more than one lawn mower barrier 3′. Alternatively, the valve 12a and/or the valve 12b could be positioned anywhere on the lawn mower barrier 3′. The illustrated valves 12a,b are valves of the manual type, but any type of valve configured for filling a fluid may be utilised. When the lawn mower barrier 3′ is to be removed, the valves 12a,b can be opened in order to empty the fluid from the barrier.

The terminal ends 6a′,b′ need not necessarily be in physical contact, but could be secured to each other by a connection element 11 such as a wire, a chain, or similar. The terminal ends 6a′,b′ may alternatively be secured directly to one another without a connection element 11 by means of threaded connections, non-threaded gender couplers or genderless couplers, flanged couplings, and similar.

The lawn mower barrier 3′ comprises two pressure sensors 9a′,b′. In the illustrated embodiment, both terminal ends 6a′,b′ of the lawn mower barrier 3′ comprises a pressure sensor 9a′,b′. In high-risk areas, there might be a demand for a second pressure sensor, and the terminal ends 6a′ and 6b′ might be similar in design, such that each terminal end 6a′,b′ thereby comprises a pressure sensor 9a′,b′. The pressure sensors 9a′,b′ are configured to monitor the pressure inside the lawn mower barrier 3′, and transmit status or deviations from a predetermined level to a controller 10′. The pressure sensors 9a′,b′ may be in communication with and transmit to the controller 10′ over the air or via cable, depending on location and equipment.

If the lawn mower barrier 3′ is compromised, i.e. a leakage occurs and the lawn mower barrier 3′ is possibly not able to prevent autonomous lawn mowers to pass by it, the pressure sensors 9a′,b′ will detect a pressure drop that is transmitted to the controller 10′ that may respond similarly to that described with reference to the first embodiment.

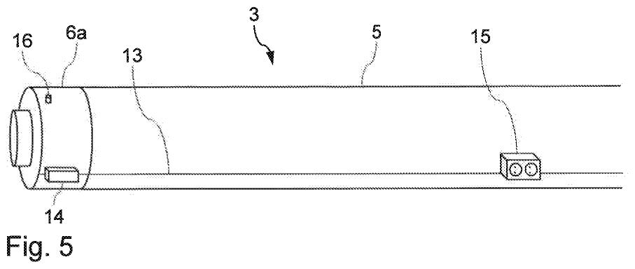

Referring now to FIG. 5, an embodiment of a lawn mower barrier 3 comprising a perimeter wire 13 is illustrated. A perimeter wire is a wire that is typically positioned around the perimeter of a designated area for lawn mowers. The perimeter wire is commonly dug into the ground and restricts the lawn mowers to the designated area. In order to cut the lawn evenly along the perimeter, lawn mowers may also every now and then be programmed to move along the perimeter wire. A lawn mower barrier 3 may comprise such a perimeter wire 13 to additionally indicate the perimeter of a designated area. The perimeter wire 13 may extend along the length of the lawn mower barrier 3, and may be connected to an electric supply 14.

The lawn mower barrier 3 may be connected to an internal or external battery (not shown), that may in turn be connected to and powered by a solar cell or equivalent power source. The lawn mower barrier 3 may as such operate off-grid. Alternatively, the electric supply 14 may be connected to a power grid. In the illustrated embodiment, the electric supply 14 is positioned at a terminal end 6a of the barrier body 5, but it may as such be positioned anywhere on the lawn mower barrier 3. Power outlets 15 may additionally be positioned along the perimeter wire 13 and/or the length of the lawn mower barrier 3. The lawn mower barrier 3 may as such distribute power to various devices connected to the power outlets 15. The power outlets 15 may be used to connect e.g. lights, speakers and various means for keeping birds away along the length of the lawn mower barrier 3.

Instead of light, the lawn mower barrier 3 may also be provided with e.g. luminescent paint or details in order to increase visibility in the dark.

In order to scare birds and rodents away, the lawn mower barrier 3 could also be used to transmit e.g. vibrations. Such vibrations could be induced anywhere along the length of the barrier and be transmitted along the length of the barrier body 5 by the barrier body 5 itself or by vibrating the liquid contained inside the hollow space. Such vibrations could generate sound and be transmitted into the ground, effectively annoying both nearby birds and rodents.

A transmitter 16 for enhancing the signals of the positioning system (GPS) used to navigate the lawn mowers may also be provided on the lawn mower barrier 3. Such a transmitter 16 may be positioned at a terminal end 6 as illustrated, or several transmitters 16 could be distributed along the length of the lawn mower barrier 3.

1. A lawn mower barrier for restricting autonomous lawn mowers to a designated area, comprising:
an elongate, pliable barrier body with two terminal ends,
wherein the barrier body has a diameter between 5-30 cm and is a liquid proof container comprising a hollow space;
the terminal ends are configured for connection to each other to form a closed loop;
the lawn mower barrier comprises a valve for filling the hollow space with a liquid.

2. The lawn mower barrier of claim 1, where the valve is provided at one of the terminal ends.

3. The lawn mower barrier of claim 1, where a valve is provided at both terminal ends.

4. The lawn mower barrier of claim 1, further comprising at least one pressure sensor for detecting leakage from the lawn mower barrier.

5. The lawn mower barrier of claim 4, where the at least one pressure sensor is provided at a terminal end.

6. The lawn mower barrier of claim 4, where the at least one pressure sensor is in communication with a controller, and the controller is configured to trigger an alarm in case of a leakage from the barrier body.

7. The lawn mower barrier of claim 1, where the liquid is water.

8. The lawn mower barrier of claim 1, where the barrier body comprises a rotationally symmetrical cross-section.

9. The lawn mower barrier of claim 1, further comprising a perimeter wire.

10. A lawn mower barrier assembly comprising a plurality of lawn mower barriers according to claim 1.

11. A method of restricting autonomous lawn mowers to a designated area, characterized in comprising the steps of:
i. placing at least one lawn mower barrier according to claim 1 along at least a portion of the periphery of the designated area,
ii. filling the at least one lawn mower barrier with a liquid,
where steps i and ii may be performed in any sequence.

12. The method of claim 11, further comprising the step of connecting the at least one lawn mower barrier end-to-end.
